(19) United States
(12) Patent Application Publication
(10) Pub. No.: US 2025/0018606 A1
(43) Pub. Date: Jan. 16, 2025

(54) PROCESSING METHOD AND PROCESSING SYSTEM FOR WIRE MESH ABNORMALITY AND ELECTRONIC DEVICE

(71) Applicant: TCL ZHONGHUAN RENEWABLE ENERGY TECHNOLOGY CO., LTD., Tianjin (CN)

(72) Inventors: Haoming ZHANG, Tianjin (CN); Xuzhou YANG, Tianjin (CN); Rui WU, Tianjin (CN); Chen WEI, Tianjin (CN); Pengzhan ZHAO, Tianjin (CN)

(73) Assignee: TCL ZHONGHUAN RENEWABLE ENERGY TECHNOLOGY CO., LTD., Tianjin (CN)

(21) Appl. No.: 18/548,576

(22) PCT Filed: Jul. 31, 2023
(86) PCT No.: PCT/CN2023/110404

§ 371 Date: Sep. 1, 2023

(30) Foreign Application Priority Data
Aug. 31, 2022 (CN) 202211052457.8

(51) Int. Cl. B28D 5/04

(52) U.S. Cl. CPC B28D 5/045

(57) ABSTRACT

A processing method for a wire mesh abnormality includes the steps of: obtaining position heights of cutting wires in a wire mesh; obtaining a jumping value of each of the cutting wires based on a vertical difference between each of the position heights of the cutting wires and a position height of a contact surface of the wire mesh and a workpiece; obtaining a jumping curve of the wire mesh based on the obtained jumping values of the cutting wires; and determining whether the wire mesh is abnormal based on the jumping curve of the wire mesh. The states of the wire mesh can be monitored in real time, the occurrence of the abnormality problem of the wire mesh can be predicted in advance, and corresponding processes can be performed in time. A processing system for a wire mesh abnormality and an electronic device are also provided.

### CROSS-REFERENCE TO RELATED APPLICATION

The present disclosure claims priority to and the benefit of Chinese Patent Application No. 202211052457.8, filed on Aug. 31, 2022, the disclosure of which is incorporated herein by reference in its entirety.

### TECHNICAL FIELD

The present disclosure relates to the technology field of slice production, and more particularly to a processing method and processing system for a wire mesh abnormality and an electronic device.

### BACKGROUND ART

During slicing, gold cutting wires are arranged in wire slots of a sheave arranged along a length direction of a slicing chamber, and the gold cutting wires are wound around outer diameter wire slots of the sheave to form a wire mesh along a length direction of the sheave. Under a normal circumstance, the wire mesh is uniformly distributed in the wire slots of the sheave. However, the gold cutting wires work at a high speed during the slicing. The taut wire mesh is pressed by a workpiece to form a wire bow. Due to effect of cutting vibration, particle impurities, and the wire bow, the wire mesh easily jumps out from the wire slots to cause wire jumping or wire merging. Friction and pressed tension of high-speed cutting cause individual wires of the wire mesh to be easily worn and broken.

The wire jumping and the wire merging are abnormal phenomena which easily occur during the slicing. The wire jumping and the wire merging can directly lead to wire disconnection. These abnormal phenomena directly affect quality of the slicing. Once a worker discovers such abnormalities, it is too late and sliced waste has already been generated. During the slicing, light in the slicing chamber is dark and there is a lot of water mist. In the meantime, the amount of cutting fluid and silica mud is large. It is impossible to monitor a position of the wire mesh during the slicing. The wire mesh which is not working properly can be discovered only when the problem of the wire jumping or the wire merging gets worse and the wire or wires are broken. This causes a machine to stop and produces a lot of bad products.

### SUMMARY OF DISCLOSURE

The present disclosure invention provides a processing method and processing system for a wire mesh abnormality and an electronic device for solving the technical problem of how to monitor states of the wire mesh in real time during a slicing process and predict the occurrence of such problems in advance so as to perform corresponding processes in time.

To solve the at least one technical problem, the present disclosure adopts the following technical solutions.

A processing method for a wire mesh abnormality includes the steps of: obtaining position heights of cutting wires in a wire mesh; obtaining a jumping value of each of the cutting wires based on a vertical difference between each of the position heights of the cutting wires and a position height of a contact surface of the wire mesh and a workpiece; obtaining a jumping curve of the wire mesh based on the obtained jumping values of the cutting wires; and determining whether the wire mesh is abnormal based on the jumping curve of the wire mesh.

In some embodiment of the present disclosure, there are multiple regions in the jumping curve of the wire mesh. Correspondingly, the step of determining whether the wire mesh is abnormal based on the jumping curve of the wire mesh in each of the regions includes: determining that at least one of the cutting wires is abnormal in one of the regions when a break point appears in the one of the region of the jumping curve, and/or a jumping value in the jumping curve is greater than a preset standard threshold value.

In some embodiment of the present disclosure, the step of obtaining the position heights of the cutting wires in the wire mesh includes: collecting position analog signals of the cutting wires in each of the regions of the jumping curve of the wire mesh; converting the collected position analog signals into digital signals; and de-noising the converted digital signals by a shift average method, a Gaussian algorithm, and a median filter algorithm to obtain the position heights of the cutting wires in each of the regions of the jumping curve of the wire mesh.

In some embodiment of the present disclosure, the step of obtaining the jumping value of each of the cutting wires based on the vertical difference between each of the position heights of the cutting wires and the position height of the contact surface of the wire mesh and the workpiece includes: obtaining the jumping value of each of the cutting wires in the one of the regions based on the vertical difference between the position height of each of the cutting wire in each of the regions corresponding to the jumping curve of the wire mesh and the position height of the contact surface between the wire mesh and the workpiece in the one of the regions; wherein the position height of the contact surface between the wire mesh and the workpiece in the one of the regions is an average position height of all the cutting wires in the one of the regions obtained based on the positon height of each of the cutting wires in each of the regions of the wire mesh.

In some embodiment of the present disclosure, when the break point appears in the one of the region of the jumping curve, it is determined that a wire merging abnormality of one of the cutting wires occurs in the one of the regions, a system warns to shut down, and the cutting wire with the wire merging is placed into an original wire slot.

In some embodiment of the present disclosure, when a jumping value of a cutting wire in the one of the regions of the jumping curve is greater than a preset standard threshold value, it is determined that a wire jumping abnormality of one of the cutting wires occurs in the one of the regions.

In some embodiment of the present disclosure, the preset standard threshold value includes a first standard threshold value and a second standard threshold value; and when a jumping value of one of the cutting lines is greater than the first standard threshold value and smaller than the second standard threshold value, a system warns to shut down, and the cutting wire with the wire jumping is placed into an original wire slot.

In some embodiment of the present disclosure, when the jumping value of the one of the cutting lines is greater than the second standard threshold value, the system warns to shut down, the one of the cutting lines and adjacent two or three cutting wires are cut off, the cut-off cutting wire is re-connected together, and the new connected cutting wire is place into the corresponding wire slot.

A processing system for a wire mesh abnormality includes: a cutting wire position obtaining module configured to obtain position heights of cutting wires in a wire mesh; a jumping value obtaining module configured to obtain a jumping value of each of the cutting wires based on a vertical difference between each of the position heights of the cutting wires and a position height of a contact surface of the wire mesh and a workpiece; a jumping curve obtaining module configured to obtain a jumping curve of the wire mesh based on the obtained jumping values of the cutting wires; and a determining module configured to determine whether the wire mesh is abnormal based on the jumping curve of the wire mesh.

In some embodiment of the present disclosure, the determining module is further configured to: determine that at least one of the cutting wires is abnormal in one of the regions when a break point appears in the one of the regions of the jumping curve, and/or a jumping value in the jumping curve is greater than a preset standard threshold value.

An electronic device includes a processor and a memory. The memory is configured to store compute programs. The processor is configured to load the computer programs to execute the steps in the processing method for the wire mesh abnormality.

Adopting the processing method and processing system for the wire mesh abnormality and the electronic device designed by the present disclosure, especially related to the wire merging abnormality and the wire jumping abnormality in slicing, can monitor the states of the wire mesh in real time during the slicing process, predict the occurrence of the abnormality problem of the wire mesh in advance, and perform corresponding processes in time, thereby reducing the occurrence frequency of the abnormal phenomena to ensure the quality of slices, improve the slicing efficiency of the workpiece, and reduce the production cost.

### BRIEF DESCRIPTION OF DRAWINGS

FIG. 1 illustrates a flow chart of a method for processing a wire mesh abnormality according to an embodiment of the present disclosure.

FIG. 2 illustrates a structural schematic diagram of a wire mesh division area according to an embodiment of the present disclosure.

FIG. 3 illustrates a structural schematic diagram of monitoring a workpiece according to an embodiment of the present disclosure.

FIG. 4 illustrates a jumping curve of a wire merging according to an embodiment of the present disclosure.

FIG. 5 illustrates a jumping curve of a wire jumping according to an embodiment of the present disclosure.

FIG. 6 illustrates a schematic structural diagram of an electronic device according to an embodiment of the present disclosure.

In the drawings:

10: workpiece; 20: wire mesh; 30: monitor; 600: electronic device; 602: processor; 604: memory.

### DETAILED DESCRIPTION OF EMBODIMENTS

The present disclosure will be described in detail below in conjunction with accompanying drawings and specific embodiments.

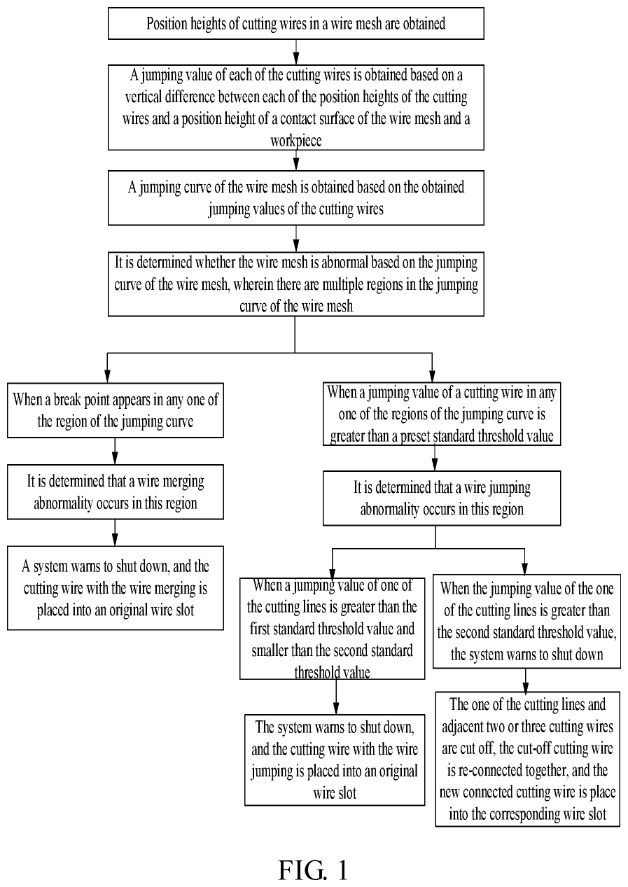

An embodiment provides a processing method for a wire mesh abnormality. As shown in FIG. 1, the method includes the following steps.

Position heights of cutting wires in a wire mesh 20 are obtained.

A jumping value of each of the cutting wires is obtained based on a vertical difference between each of the position heights of the cutting wires and a position height of a contact surface of the wire mesh 20 and a workpiece 10.

A jumping curve of the wire mesh 20 is obtained based on the obtained jumping values of the cutting wires.

It is determined whether the wire mesh 20 is abnormal based on the jumping curve of the wire mesh 20.

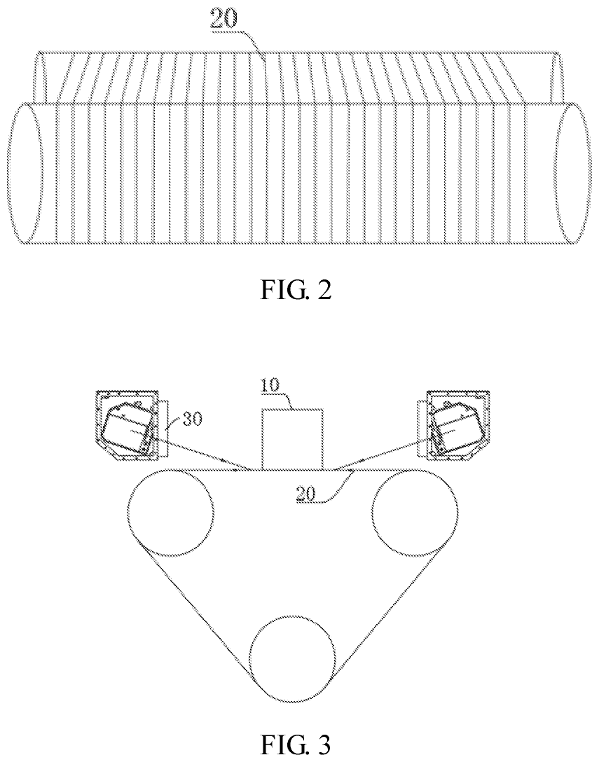

There are multiple regions in the jumping curve of the wire mesh 20. The wire mesh 20 is divided into multiple uniform regions along a length direction of the wire mesh 20, that is, a length direction in which the workpiece 10 is placed. A region distribution is shown in FIG. 2. The wire mesh 20 in each of the regions includes multiple cutting wires. The jumping curve of the cutting wires in the wire mesh 20 in each of the regions is separately analyzed to determine whether the wire mesh 20 in this region is abnormal.

Correspondingly, the step of determining whether the wire mesh 20 is abnormal based on the jumping curve of the wire mesh 20 in each of the regions includes determining that at least one of the cutting wires is abnormal in this region when a break point appears in any one of the region of the jumping curve, and/or a jumping value in the jumping curve is greater than a preset standard threshold value.

Specifically, during slicing, the position heights of all the cutting wires in each of the regions of the wire mesh 20 are obtained first.

Position analog signals of all the cutting wires in each of the regions of the jumping curve of the wire mesh 20 are collected.

Then, the collected position analog signals are converted into digital signals.

Then, the converted digital signals are de-noised by a shift average method, a Gaussian algorithm, and a median filter algorithm to obtain the position heights of all the cutting wires in each of the regions of the jumping curve corresponding to the wire mesh 20.

Specifically, the position signals of all the cutting wires in each of the regions of the wire mesh 20 are collected by detecting, by monitors 30 arranged in a slicing chamber, the position of the wire mesh 20 during a process of cutting the workpiece 10. Since the length of the workpiece 10 is set across the length of the wire mesh 20, the monitors 30 detect, along the length direction of the wire mesh 20, the positions of the cutting wires in each of the regions at a uniform moving speed, so as to obtain the position height of each of the cutting wires.

The monitors 30 are arranged symmetrically with respect to the workpiece 10. The structure is shown in FIG. 3. All emission ports of the monitors 30 are set toward one side of the workpiece 10. That is, all the emission ports of the monitors 30 are set toward a rotation direction of the wire mesh 20. Preferably, the monitors 30 detect the wire mesh 20 in the same direction as the emission ports, and the monitors 30 alternately monitor the wire mesh 20 during wire feeding and the wire mesh 20 during wire take-up.

That is, the monitors 30 are controlled to continuously and sequentially detect, along the length direction of the workpiece 10, a position of a lowest point of all the cutting wires in each of the regions of the wire mesh 20. The monitors 30 are set in non-contact with the wire mesh 20 and continuously and sequentially detect, along the length direction of the workpiece 10, the position heights of the cutting wires in each of the regions of the wire mesh 20. The monitors 30 can be radar sensors or laser sensors. This type of sensors can continuously and uninterruptedly transmit a signal to and collect a return signal from the position of each of the cutting wires without difficulty, so as to identify the position of each of the cutting wires in each of the regions. Especially in the slicing chamber where light is dark during the slicing, the position detection of each of the cutting wires can be completed. Not only identification effect is good, but also detection accuracy is high. Furthermore, the position detection is not affected by water mist.

During the slicing, the wire mesh 20 cuts the workpiece 10 by reciprocating rotation, and its operation mainly has two rotation directions, that is, forward rotation during the wire feeding and reverse rotation during the wire take-up. The forward rotation and the reverse rotation appear alternately. During the whole cutting process, a length of the forward rotation and a length of the reverse rotation are constant, and a wire feeding length during the forward rotation is greater than a wire take-up length during the reverse rotation, so that the workpiece 10 can always be cut by a new wire and utilization of the cutting wires can be maximized. Since the rotation direction of the wire mesh 20 directly affects a direction of splashing cutting fluid, the cutting fluid splashes along the rotation direction of the wire mesh 20 when the wire mesh 20 rotates. Therefore, the emission ports of the monitors 30 need to detect along the rotation direction of the wire mesh 20. That is, the emission ports of the monitors 30 and the rotation direction of the wire mesh 20 rotate in the same direction, thereby reducing the splash of the cutting fluid and silica mud caused by the rotation of the wire mesh 20 to ensure the accuracy of the detection and identification.

During working, the monitors 30 placed at two sides of the wire mesh 20 along a width direction monitor the wire mesh 20 during the wire feeding and the wire mesh 20 during the wire take-up respectively, and the monitors 30 placed at the two sides of the wire mesh 20 along the width direction alternately detect when the forward rotation of the wire mesh 20 during the wire feeding and the reverse rotation of the wire mesh 20 during the wire take-up are switched to each other. That is, when the wire mesh 20 rotates in the forward direction, the monitor 30 arranged in the same direction as the rotation of the wire mesh 20 detects the position of each of the cutting wires of the wire mesh 20, and the monitor 30 at the other side suspends work. When the wire mesh 20 rotates in the reverse direction, the monitor 30 arranged in the same direction as the rotation of the wire mesh 20 detects the position of each of the cutting wires of the wire mesh 20, and the monitor 30 at the other side suspends work. The two monitors 30 work alternately and can monitor working states of the wire mesh 20 in the whole process without missing any operations.

The monitors 30 can collect the position analog signals of the cutting wires through light wave reflection or laser reflection. The monitors 30 automatically convert the collected position analog signals into the digital signals and transmit them to an external controller (not shown in the drawings).

Then, the controller sequentially uses the shift average method, the Gauss algorithm, and the median filter algorithm to de-noise the converted digital signals to obtain the position height of each of the cutting wires in each of the regions of the wire mesh 20.

Then, an average position height of all the cutting wires in each of the regions corresponding to the jumping curve of the wire mesh 20 relative to the contact surface of the workpiece 10 can be calculated based on the position height of each of the cutting wires in each of the regions corresponding to the jumping curve of the wire mesh 20. The controller can automatically process the data to obtain the average position height (that is, the position height of the contact surface between the wire mesh 20 and the workpiece 10 in this region) of all the cutting wires in each of the regions corresponding to the jumping curve of the wire mesh 20 relative to the contact surface of the workpiece 10.

Then, the jumping value of each of the cutting wires in this regions is obtained based on the vertical difference between the position height of each of the cutting wire in each of the regions corresponding to the jumping curve of the wire mesh 20 and the position height of the contact surface between the wire mesh 20 and the workpiece 10 in this region. The controller can automatically calculate the vertical difference between each of the cutting wires in this region and the contact surface between the wire mesh 20 and the workpiece 10 in this region. The vertical difference is the jumping value of each of the cutting wires in this region.

The jumping values of all the cutting wires in this region are connected based on the jumping values of all the cutting wires in each of the regions in the wire mesh 20, so as to obtain a jumping curve graph in which an X-axis represents a length of each of the regions and a Y-axis represents the jumping values of all the cutting wires. The jumping curve is a corresponding jumping curve of the wire mesh 20 which is formed by connecting the calculated jumping values together by the controller and is directly displayed on a display of a slicer. The monitors 30 detect the position analog signal of each of the cutting wires in each of the regions of the wire mesh 20. The monitors 30 process it into the digital signal and transmit it to the controller by themselves. After the digital signal is processed by the controller, position basic data of each of the cutting wires in each of the regions can be obtained. The position basic data of each of the cutting wires in each of the regions is processed by a calculation formula to obtain data of the jumping values required by the jumping curve, and then the corresponding jumping curve graph is directly displayed on the display.

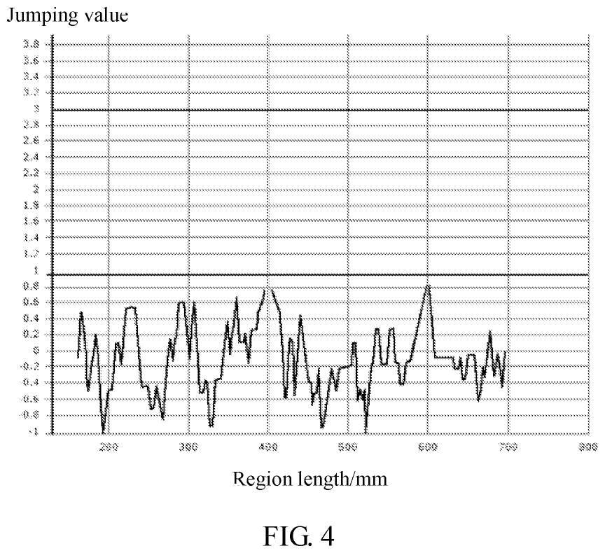

During the slicing process, due to effect of vibration of the slicer and friction between the workpiece 10 and the gold cutting wires, not all cutting wires are stable at a position height. The cutting wires fluctuate up and down, and even wire merging or wire jumping phenomenon occurs. Once an abnormality occurs, the jumping curve can show this result. The jumping values of all the cutting wires in each of the regions in the wire mesh 20 appear continuously in the jumping curve, and all the jumping values are connected together to online form the continuous jumping curve with certain fluctuations online. The distribution of the jumping values of all the cutting wires along the length direction of the wire mesh 20 can be shown from the jumping curve in FIG. 4.

The wire merging means that two or more cutting wires are merged in the same wire slot, and there is no cutting wire in an empty wire slot. As such, the monitors 30 cannot detect the cutting wire in the empty wire slot. That is, the monitors 30 cannot detect the position signal of the merged cutting wire. This results in no data of the jumping value of the merged cutting wire, and thus a break point is displayed on the jumping curve. That is, when a break point occurs at any position in the wire mesh 20, it means that the cutting wire at this position is not detected by the monitors 30. That is, the wire merging phenomenon occurs. In a case of normal cutting, the wire mesh 20 is uniformly distributed in the wire slots of the sheave. After the analog signals collected by the monitors 30 are finally converted into a digital curve, all the jumping values are connected together to form a curve which is continuous and fluctuates up and down within a certain range. Once wire merging occurs, the cutting wires in adjacent wire slots are merged together. The monitors 30 cannot collect the analog signal of this position, and then the converted position data cannot be obtained. A break point is displayed on the jumping curve, which means that a wire merging abnormality occurs. As shown in FIG. 4, a break point appears at a position of 400 mm. It means that the monitors 31 cannot detect the position signal of the cutting wire at this position. This results in that the jumping value has no data, and the break point is displayed on the jumping curve to indicate that the wire merging abnormality occurs at this position. Correspondingly, a red warning line corresponding to a region in FIG. 2 appears on the display to indicate that the cutting wire with the wire merging abnormality is located in this region. A worker can directly identify the location of the region of the cutting wire with the problem of the wire merging abnormality from FIG. 2. At this time, the monitors 30 notify an alarm system of the slicer through the controller, and the system warns to shut down. Manual operations start to aim to the position of the corresponding region to identify the cutting wire with the wire merging abnormality in this region quickly and accurately and place it into the original wire slot.

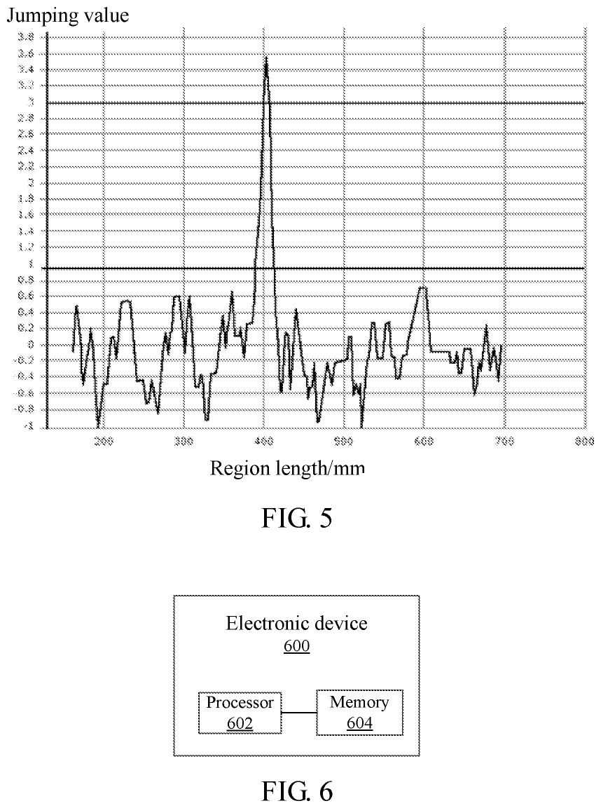

When the wire jumping occurs, a distance between a cutting wire and the contact surface between the wire mesh 20 and the workpiece 10 is relatively high. Accordingly, the jumping value is relatively large, and a very high jumping value appears when the jumping curve is displayed. As shown in FIG. 5, the jumping curve of the wire mesh 20 is always continuous. When a jumping value of a cutting wire at any one position is greater than a preset standard threshold value, it can be determined that the wire mesh at this position has a wire jumping abnormality. During the slicing process, when there is no wire jumping, the jumping curve is continuous and stable. Once the wire jumping of the cutting wire occurs, the cutting wire with the wire jumping has a certain height difference relative to the contact surface between the wire mesh 20 and the workpiece 10 in the vertical direction. This height difference is the jumping value. A change of the jumping value is directly reflected on the jumping curve on the display. It can be clearly seen from the jumping curve graph that the jumping value of the cutting wire with the wire jumping has a larger protrusion. When the wire jumping is larger, the protrusion of the jumping curve is more obvious. Correspondingly, when the wire jumping abnormality occurs, a red warning line corresponding to a region in FIG. 2 appears on the display to indicate that the cutting wire with the wire jumping abnormality is located in this region. A worker can directly identify the location of the region of the cutting wire with the problem of the wire jumping abnormality from FIG. 2 and can directly find out the position of the corresponding region in the wire mesh 20 in the slicing chamber.

A range of the standard threshold value of each of the cutting wire is obtained based on a jumping state of each of the cutting wire during normal cutting. A measured jumping value is compared with the preset standard threshold value. When the wire jumping occurs, the jumping value of the cutting wire relative to the contact surface between the wire mesh 20 and the workpiece 10 is changed.

Specifically, the preset standard threshold value includes a first standard threshold value and a second standard threshold value. The first standard threshold value is smaller than the second standard threshold value. Two standard threshold values are set for the purpose of determining the severity of the wire jumping.

When the jumping value at any position is greater than the first standard threshold value and smaller than the second standard threshold value, the controller notifies the alarm system of the slicer based on the determination result and the control system warns to shut down. Manual operations start to directly find out the region where the red warning line is located at the corresponding position in the wire meshwork 20 in FIG. 2, quickly and accurately find out the cutting wire with the wire jumping abnormality in this region, and place it into the original wire slot. At this time, as long as the cutting wire with the wire jumping abnormality is placed into the original slot, the slicing process can continue.

When the jumping value at any position is greater than the second standard threshold value, it means that the cutting wire with the wire jumping is seriously deformed and cannot cut the workpiece 10. When the cutting wire with the wire jumping is still used to cut the workpiece 10, the cutting line is broken. This also results in more slices with poor cut-quality being produced. At this time, the controller notifies the alarm system of the slicer based on the determination, and the control system warns to shut down. Manual operations start to directly find out the region where the red warning line is located at the corresponding position in the wire meshwork 20 in FIG. 2 and quickly and accurately find out the cutting wire with the wire jumping abnormality in this region. The cutting wire with the wire jumping and adjacent 2-3 cutting wires are cut off. Then, the cut-off cutting wire is re-connected together, and the new connected cutting wire is place into the corresponding wire slot to continue the slicing process.

As shown in FIG. 5. FIG. 5 illustrates a wire jumping curve graph measured during slicing, that is, a jumping curve graph. It is assumed that the first standard threshold value is 1 mm and the second standard threshold value is 3 mm. It is obvious from FIG. 5 that a jumping value of a cutting wire at a position of 400-500 mm in a length of the workpiece 10 is greater than the second standard threshold of 3 mm, and jumping values of cutting wires at other positions are all smaller than 1 mm. This means that the cutting wire with the wire jumping occurs at the position of 400-500 mm. The deformation is greater than the limitation of the second standard threshold value of 3 mm. The controller notifies the wire cutting machine to shut down. The cutting wire at this position cannot be placed into the original wire slot manually and cannot be used again. At this time, it is necessary to manually cut off the cutting wire with the wire jumping and adjacent 2-3 cutting wires, re-weld the cut-off cutting wire in the wire slot with a new wire to correct the cutting wire again, and place it is into the original wire slot to continue the slicing process.

When a jumping value of a cutting wire at any position is greater than the first standard threshold value of 1 mm and is smaller than the second standard threshold value of 3 mm, the controller notifies the wire cutting machine to shut down. Manual operations are performed on the cutting wire with the wire jumping to place the cutting wire with the wire jumping into the original wire slot to continue the slicing process.

Further, when the jumping curve in FIG. 5 has a break point and a phenomenon of exceeding the standard threshold value, there must be abnormalities in this region including both a wire merging abnormality and a wire jumping abnormality. Correspondingly, the corresponding regions of the wire mesh in FIG. 2 are indicated by red alarm lines. At this time, the controller notifies the alarm system of the cutting machine based on the determining results, and the control system warns to shut down. Manual operations start to directly find out the regions where the red warning lines are located at the corresponding positions in the wire meshwork 20 in FIG. 2 and quickly and accurately find out the cutting wire with the wire merging abnormality and the cutting wire with the wire jumping abnormality in these regions. Subsequent processes are performed based on the above-mentioned determining steps.

A processing system for a wire mesh abnormality includes:
a cutting wire position obtaining module configured to obtain position heights of cutting wires in a wire mesh 20;
a jumping value obtaining module configured to obtain a jumping value of each of the cutting wires based on a vertical difference between each of the position heights of the cutting wires and a position height of a contact surface of the wire mesh 20 and a workpiece 10;
a jumping curve obtaining module configured to obtain a jumping curve of the wire mesh 20 based on the obtained jumping values of the cutting wires; and
a determining module configured to determine whether the wire mesh 20 is abnormal based on the jumping curve of the wire mesh 20.

The determining module is further configured to:
determine that at least one of the cutting wires is abnormal in one of the regions when a break point appears in the one of the regions of the jumping curve, and/or a jumping value in the jumping curve is greater than a preset standard threshold value.

Please refer to FIG. 6. FIG. 6 illustrates a schematic structural diagram of an electronic device 600 provided by an embodiment of the present disclosure.

The electronic device 600 at least includes a processor 602 and a memory 604. The memory 604 is configured to store compute programs, and the processor 602 is configured to load the computer programs to execute the steps in the processing method in any one of the above-mentioned embodiments.

Adopting the processing method and processing system for the wire mesh abnormality designed by the present disclosure can monitor the states of the wire mesh in real time during the slicing process, predict the occurrence of the abnormality problem of the wire mesh in advance, and perform corresponding processes in time, thereby reducing the occurrence frequency of the abnormal phenomena to ensure the quality of slices, improve the slicing efficiency of the workpiece, and reduce the production cost.

The embodiments of the present disclosure are described in detail above, and the content described is only a preferred embodiment of the present disclosure and should not be considered as limiting the implementation scope of the present disclosure. All equivalent changes and improvements made according to the claims of the present disclosure shall still belong to the scope of protection covered by the present disclosure.

What is claimed is:

1. A processing method for a wire mesh abnormality, comprising the steps of:
obtaining position heights of cutting wires in a wire mesh;
obtaining a jumping value of each of the cutting wires based on a vertical difference between each of the position heights of the cutting wires and a position height of a contact surface of the wire mesh and a workpiece;
obtaining a jumping curve of the wire mesh based on the obtained jumping values of the cutting wires; and
determining whether the wire mesh is abnormal based on the jumping curve of the wire mesh.

2. The processing method for the wire mesh abnormality of claim 1, wherein there are multiple regions in the jumping curve of the wire mesh;
correspondingly, the step of determining whether the wire mesh is abnormal based on the jumping curve of the wire mesh in each of the regions comprises:
determining that at least one of the cutting wires is abnormal in one of the regions when a break point appears in the one of the region of the jumping curve, and/or a jumping value in the jumping curve is greater than a preset standard threshold value.

3. The processing method for the wire mesh abnormality of claim 2, wherein the step of obtaining the position heights of the cutting wires in the wire mesh comprises:
collecting position analog signals of the cutting wires in each of the regions of the jumping curve of the wire mesh;
converting the collected position analog signals into digital signals; and
de-noising the converted digital signals by a shift average method, a Gaussian algorithm, and a median filter algorithm to obtain the position heights of the cutting wires in each of the regions of the jumping curve of the wire mesh.

4. The processing method for the wire mesh abnormality of claim 3, wherein the step of obtaining the jumping value of each of the cutting wires based on the vertical difference between each of the position heights of the cutting wires and the position height of the contact surface of the wire mesh and the workpiece comprises:
obtaining the jumping value of each of the cutting wires in the one of the regions based on the vertical difference between the position height of each of the cutting wire in each of the regions corresponding to the jumping curve of the wire mesh and the position height of the contact surface between the wire mesh and the workpiece in the one of the regions;
wherein the position height of the contact surface between the wire mesh and the workpiece in the one of the regions is an average position height of all the cutting wires in the one of the regions obtained based on the positon height of each of the cutting wires in each of the regions of the wire mesh.

5. The processing method for the wire mesh abnormality of claim 2, wherein when the break point appears in the one of the region of the jumping curve, it is determined that a wire merging abnormality of one of the cutting wires occurs in the one of the regions, a system warns to shut down, and the cutting wire with the wire merging is placed into an original wire slot.

6. The processing method for the wire mesh abnormality of claim 2, wherein when a jumping value of a cutting wire in the one of the regions of the jumping curve is greater than a preset standard threshold value, it is determined that a wire jumping abnormality of one of the cutting wires occurs in the one of the regions.

7. The processing method for the wire mesh abnormality of claim 6, wherein the preset standard threshold value comprises a first standard threshold value and a second standard threshold value; and
when a jumping value of one of the cutting lines is greater than the first standard threshold value and smaller than the second standard threshold value, a system warns to shut down, and the cutting wire with the wire jumping is placed into an original wire slot.

8. The processing method for the wire mesh abnormality of claim 7, wherein when the jumping value of the one of the cutting lines is greater than the second standard threshold value, the system warns to shut down, the one of the cutting lines and adjacent two or three cutting wires are cut off, the cut-off cutting wire is re-connected together, and the new connected cutting wire is place into the corresponding wire slot.

9. A processing system for a wire mesh abnormality, comprising:
a cutting wire position obtaining module configured to obtain position heights of cutting wires in a wire mesh;
a jumping value obtaining module configured to obtain a jumping value of each of the cutting wires based on a vertical difference between each of the position heights of the cutting wires and a position height of a contact surface of the wire mesh and a workpiece;
a jumping curve obtaining module configured to obtain a jumping curve of the wire mesh based on the obtained jumping values of the cutting wires; and
a determining module configured to determine whether the wire mesh is abnormal based on the jumping curve of the wire mesh.

10. The processing system for the wire mesh abnormality of claim 9, wherein the determining module is further configured to:
determine that at least one of the cutting wires is abnormal in one of the regions when a break point appears in the one of the regions of the jumping curve, and/or a jumping value in the jumping curve is greater than a preset standard threshold value.

11. An electronic device, comprising a processor and a memory, wherein the memory is configured to store compute programs, and the processor is configured to load the computer programs to execute the steps of:
obtaining position heights of cutting wires in a wire mesh;
obtaining a jumping value of each of the cutting wires based on a vertical difference between each of the position heights of the cutting wires and a position height of a contact surface of the wire mesh and a workpiece;
obtaining a jumping curve of the wire mesh based on the obtained jumping values of the cutting wires; and
determining whether the wire mesh is abnormal based on the jumping curve of the wire mesh.

12. The electronic device of claim 11, wherein there are multiple regions in the jumping curve of the wire mesh;
correspondingly, the step of determining whether the wire mesh is abnormal based on the jumping curve of the wire mesh in each of the regions comprises:
determining that at least one of the cutting wires is abnormal in one of the regions when a break point appears in the one of the region of the jumping curve, and/or a jumping value in the jumping curve is greater than a preset standard threshold value.

13. The electronic device of claim 12, wherein the step of obtaining the position heights of the cutting wires in the wire mesh comprises:
collecting position analog signals of the cutting wires in each of the regions of the jumping curve of the wire mesh;
converting the collected position analog signals into digital signals; and
de-noising the converted digital signals by a shift average method, a Gaussian algorithm, and a median filter algorithm to obtain the position heights of the cutting wires in each of the regions of the jumping curve of the wire mesh.

14. The electronic device of claim 13, wherein the step of obtaining the jumping value of each of the cutting wires based on the vertical difference between each of the position heights of the cutting wires and the position height of the contact surface of the wire mesh and the workpiece comprises:
obtaining the jumping value of each of the cutting wires in the one of the regions based on the vertical difference between the position height of each of the cutting wire in each of the regions corresponding to the jumping curve of the wire mesh and the position height of the contact surface between the wire mesh and the workpiece in the one of the regions;
wherein the position height of the contact surface between the wire mesh and the workpiece in the one of the regions is an average position height of all the cutting wires in the one of the regions obtained based on the positon height of each of the cutting wires in each of the regions of the wire mesh.

15. The electronic device of claim 12, wherein when the break point appears in the one of the region of the jumping curve, it is determined that a wire merging abnormality of one of the cutting wires occurs in the one of the regions, a system warns to shut down, and the cutting wire with the wire merging is placed into an original wire slot.

16. The electronic device of claim 12, wherein when a jumping value of a cutting wire in the one of the regions of the jumping curve is greater than a preset standard threshold value, it is determined that a wire jumping abnormality of one of the cutting wires occurs in the one of the regions.

17. The electronic device of claim 16, wherein the preset standard threshold value comprises a first standard threshold value and a second standard threshold value; and
when a jumping value of one of the cutting lines is greater than the first standard threshold value and smaller than the second standard threshold value, a system warns to shut down, and the cutting wire with the wire jumping is placed into an original wire slot.

18. The electronic device of claim 17, wherein when the jumping value of the one of the cutting lines is greater than the second standard threshold value, the system warns to shut down, the one of the cutting lines and adjacent two or three cutting wires are cut off, the cut-off cutting wire is re-connected together, and the new connected cutting wire is place into the corresponding wire slot.
